(19) United States
(12) Patent Application Publication
(10) Pub. No.: US 2020/0027106 A1
(43) Pub. Date: Jan. 23, 2020

(54) SWEEPSTAKES CAMPAIGN SYSTEM AND USES THEREOF

(71) Applicant: ROK Mobile International Ltd., Culver City, CA (US)

(72) Inventor: JONATHAN KENDRICK, Culver City, CA (US)

(21) Appl. No.: 16/519,885

(22) Filed: Jul. 23, 2019

Related U.S. Application Data
(60) Provisional application No. 62/701,886, filed on Jul. 23, 2018.

(51) Int. Cl. G06Q 30/02; G06N 3/08; G06N 3/04; G06K 9/62; G06K 9/00

(52) U.S. Cl. CPC G06Q 30/0209; G06N 3/08; G06T 1/0021; G06K 9/6201; G06K 9/00201; G06N 3/04

(57) ABSTRACT

The present disclosure relates to sweepstakes campaign system wherein consumers are given a clue to find a consumer good in a retail store. The consumer locates the good and places the good within the field of view of a camera of a mobile device or takes a picture of the good with the camera on the mobile device. The mobile device or a server can extract an object from the field of view or from the image and determine if the extracted object is a good and determine whether the good is correct. If the consumer has located the correct good, the consumer will be provided with the next reward clue and either a message or a good clue. The sweepstakes campaign can conclude with one or more winners being provided the location(s) or method of obtaining a reward.

### CROSS-REFERENCE TO RELATED PATENT APPLICATION

This application claims priority to U.S. Provisional Application No. 62/701,886, which was filed on Jul. 23, 2018, and is herein incorporated by reference in its entirety.

### BACKGROUND

Sweepstakes, lotteries, and other games have been around for some time. Typically such games involve users mailing in entries (sometimes based on purchases) or submitting an entry via a website. Oftentimes opportunities to engage users in consumer activity is limited, little to no data is collected, and users are not involved in marketing consumer goods as part of the game. These and other shortcomings are addressed herein.

### SUMMARY

It is to be understood that both the following general description and the following detailed description are exemplary and explanatory only and are not restrictive. The present disclosure relates to sweepstakes campaign system wherein consumers are given a clue, via an application installed on a mobile device, to find a consumer good or any other product/service. Alternatively, the application can provide the consumer with a specific good or service to locate in order to receive a clue to the reward. The consumer locates the good and scans the good with a camera of a mobile device via an application installed on the mobile device. The application can extract an object from the image and determine if the extracted object is the good the consumer was instructed to find, or is a solution to a clue. If the consumer has located the correct good, the consumer will be provided with the next clue via the application.

Alternatively, the consumer locates the good and takes a picture (e.g., image) of the good via the application. The application can upload the image to a server. The server can extract an object from the image and determine if the extracted object is a good and determine whether the good is correct. If the consumer has located the correct good, the consumer will be provided with the next clue.

The sweepstakes campaign can conclude with one or more winners being provided a reward and/or a location(s) of a reward. Additional advantages will be set forth in part in the description which follows or may be learned by practice. The advantages will be realized and attained by means of the elements and combinations particularly pointed out in the appended claims.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 illustrates a sweepstakes campaign system;

FIG. 2 illustrates a sweepstakes campaign system;

FIG. 3A depicts a user interface of an application configured to operate with a sweepstakes campaign system;

FIG. 3B depicts a user interface of an application configured to operate with a sweepstakes campaign system;

FIG. 3C depicts a user interface of an application configured to operate with a sweepstakes campaign system;

FIG. 4 depicts a user interface of an application configured to operate with a sweepstakes campaign system;

FIG. 5 is a flowchart illustrating an example method;

FIG. 6 is a flowchart illustrating an example method; and

FIG. 7 is an example operating environment.

### DETAILED DESCRIPTION

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

The present disclosure relates to sweepstakes campaign system wherein consumers are given instructions to locate a specific consumer good and/or are provided a clue to find the consumer good. The consumer good can anything a consumer might purchase, from food items, to vehicles, to music, concert tickets, etc. The consumer locates the good and launches an application installed on the consumer's mobile device. The application can utilize the mobile device's camera to scan the good or, alternatively, take a picture of the good. The application can extract an object from the image and determine if the extracted object is a good and determine whether the good is correct. If the consumer has located the correct good, the consumer will be provided with the next clue. Alternatively, the application can transmit/upload the picture to a server. The server can extract an object from the image and determine if the extracted object is a good and determine whether the good is correct.

If the consumer has located the correct good, the consumer will be provided with the next clue to find the reward and will be either instructed to find another good for the next clue to find the reward or a clue as to the next good to find. The sweepstakes campaign can conclude with one or more winners being provided a rewards and/or the location(s) of a reward (e.g., buried treasure). For example, somewhere within a geographic region one or more locations (e.g., indicated by x's) can be provided to the ultimate winning consumer(s). In the process, consumers have been driven to certain brands, products, retail locations, and the like. The sweepstakes campaign can thus be used to generate advertising revenues that exceed the value of the rewards. Moreover, consumer behavior can be tracked via the applications installed on the mobile devices. The consumer behavior can be used for further marketing purposes.

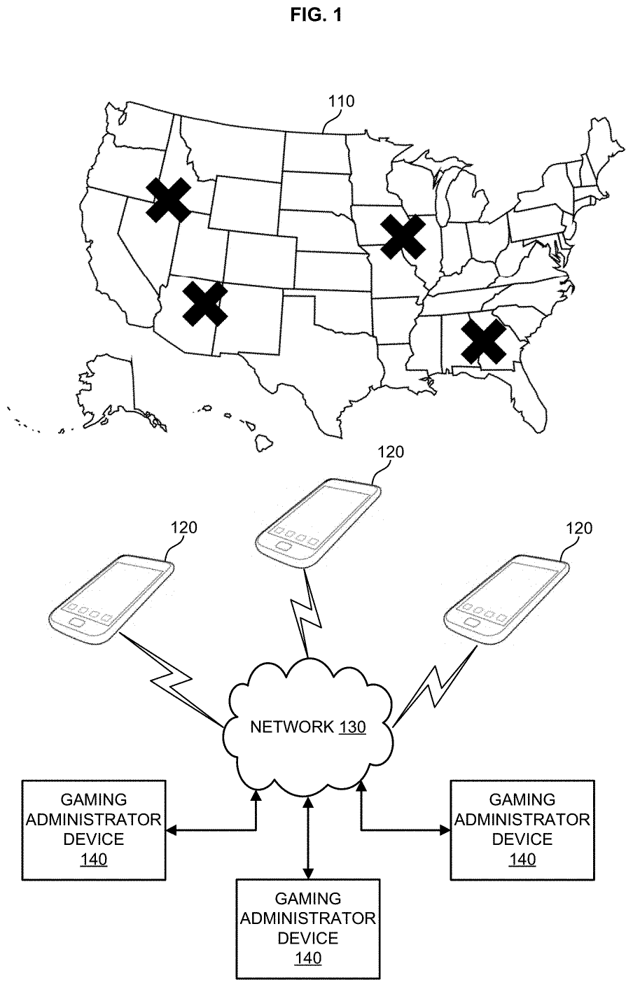

FIG. 1 illustrates various aspects of an exemplary environment in which the present methods and systems can operate. The present disclosure is relevant to systems and methods for providing sweepstakes and gaming-related services to a device, for example, a mobile device 120 such as a computer, tablet, smartphone, communications terminal, or the like. The mobile device 120 can be in communication with one or more gaming administrator devices 140, such as a server, for example. The gaming administrator devices 140 can be disposed locally or remotely relative to the mobile device 120. As an example, the mobile device 120 and the one or more gaming administrator devices 140 can be in communication via a network 130. The network 130 can comprise a packet switched network (e.g., interne protocol based network), a non-packet switched network (e.g., quadrature amplitude modulation based network, POTS), and/or the like. The network 130 can comprise network adapters, switches, routers, modems, and the like connected through wireless links (e.g., cellular, radio frequency, satellite) and/or physical links (e.g., fiber optic cable, coaxial cable, Ethernet cable, or a combination thereof). The network 130 can comprise public networks, private networks, wide area networks (e.g., Internet), local area networks, and/or the like. The network 130 can be configured to provide communication from telephone, cellular, modem, and/or other electronic devices to and throughout the system 100.

In an aspect, the mobile device 120 can comprise a smartphone. The mobile device 120 can be configured to communicate via one or more of second generation (2G), third generation (3G), fourth generation (4G), fifth generation (5G), GPRS, EDGE, D2D, M2M, long term evolution (LTE), long term evolution advanced (LTE-A), code division multiple access (CDMA), wideband code division multiple access (WCDMA), universal mobile telecommunications system (UMTS), wireless broadband (WiBro), Voice Over IP (VoIP), and global system for mobile communication (GSM). The mobile device 120 can further be configured for communication over a local area network connection through network access points using technologies such as IEEE 802.11. The mobile device 120 can further be configured for communication over Bluetooth and/or near field communications (NFC). The mobile device 120 can comprise a GPS receiver that can receive position information from a constellation of satellites operated by the U.S. Department of Defense. Alternately, the GPS receiver can be a GLONASS receiver operated by the Russian Federation Ministry of Defense, or any other positioning device capable of providing accurate location information (for example, LORAN, inertial navigation, and the like). The GPS receiver can contain additional logic, either software, hardware or both to receive the Wide Area Augmentation System (WAAS) signals, operated by the Federal Aviation Administration, to correct dithering errors and provide the most accurate location possible. The mobile device 120 can comprise a camera or other image sensor configured to capture both still and moving images. The camera may capture images within the visible spectrum portion of the electromagnetic spectrum that is visible to the human eye. The camera may also capture images outside the visible spectrum portion of the electromagnetic spectrum including infrared and ultraviolet. The camera may be of a complementary metal oxide semiconductor (CMOS) type or a semiconductor charge coupled device (CCD) type and may include an image focusing lens and an image zoom function. The mobile device 120 can have installed thereon an application configured for enabling a user of the mobile device 120 (e.g., a consumer) to engage in the sweepstakes campaign.

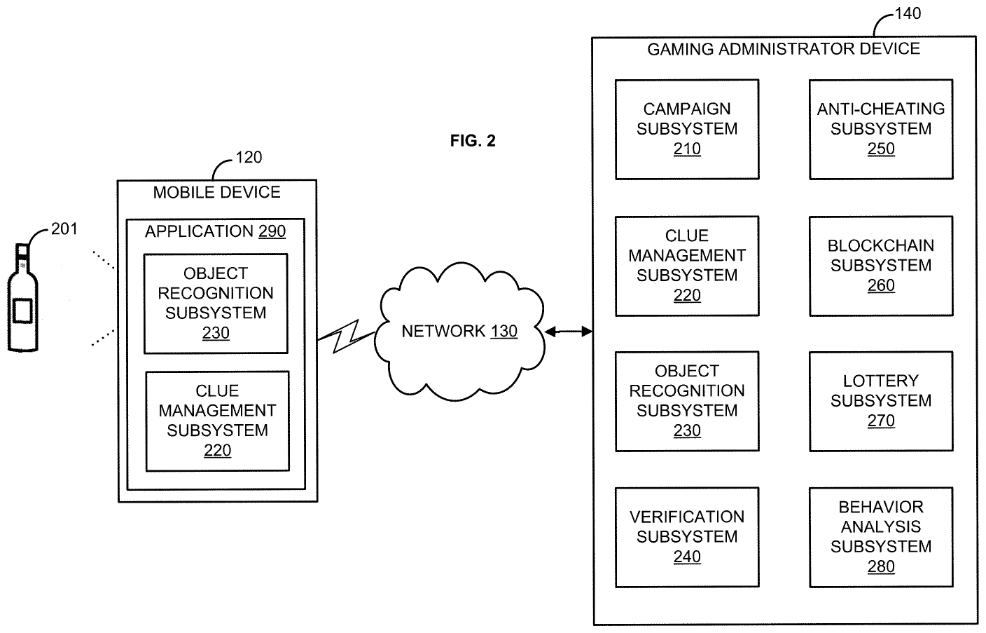

FIG. 2 illustrates an operating environment for conducting the sweepstakes campaign. The gaming administrator device 140 can comprise a plurality of subsystems for accomplishing the sweepstakes. The gaming administrator device 140 can comprise a campaign subsystem 210, a clue management subsystem 220, an object recognition subsystem 230, a verification subsystem 240, an anti-cheating subsystem 250, a blockchain subsystem 260, a lottery subsystem 270, a behavior analysis subsystem 280, combinations thereof, and the like.

In an aspect, the campaign subsystem 210 can be configured to allow a user, such as a marketing agency, a brand management agency, or any company offering goods/services for sale, to configure a sweepstakes campaign. The user can specify a good or service that the user wishes consumers to locate. The user can specify a message that directs the user to locate the good in order to find a reward clue (e.g., “Go find a bottle of ABK Beer to get a clue to the treasure!”). The user can also specify one or more good clues that can be used by the consumer to locate the good (e.g., “Go find a bottle of beer from a brewery that dates back over 700 years and continues to use the same locally grown Hallertau hops and grains from the same local farms to get a clue to the treasure!”). The message and/or the one or more good clues can be provided to the clue management subsystem 220 for later processing. The message and/or the one or more good clues can be any information usable by a consumer to locate a good or service. For example, a good clue can be GPS coordinates, the name (or partial name) of the good or service, a description of the good or service, a coded message, an image, a video clip, an advertisement, audio, a game, a puzzle, a hint, combinations thereof, and the like.

The user can upload one or more images of the good, including 2D and/or 3D image files of the good. Any 2D image file can be used including, but not limited to, Portable Document Format (.PDF), JPEG (.JPG) format, Portable Network Graphics (.PNG) format, Adobe® Photoshop® (.PSD) format, and the like. Any 3D image file can be used including, but not limited to, STL, OBJ, FBX, COLLADA, 3DS, IGES; STEP, and VRML/X3D. The 3D image file store information about 3D models of a good as plain text or binary data. In particular, the 3D image file encodes at least the 3D model's geometry and/or appearance. The geometry of a model describes its shape. The appearance of a model includes, for example, colors, textures, material type, and the like. The 2D and/or 3D image files of the good can be provided to the object recognition subsystem 230 for later processing.

The user can further utilize the campaign subsystem 210 to apply various restrictions to participation in the sweepstakes campaign. Such restrictions can include for example, restrictions to a specific time range, a specific group and/or class of consumers (e.g., by demographic, by location, by service provider, by device, etc.), a specific geographic region, a specific retail chain, and/or one or more specific retail locations. The user can specify a time that the sweepstakes campaign will begin and a time the sweepstakes campaign will end. The restrictions can be provided to the verification subsystem 240 for later processing.

The user can specify one or more rewards, including reward tiers. For example, the user can specify one of more final rewards (e.g., grand prize) of $1 million dollars in cash, precious metals, gems, and the like. The user can specify reward tiers wherein each tier represents different odds of winning. For example, a grand prize can reside in the highest reward tier and have the lowest odds of winning whereas a minor prize can reside in the lowest reward tier and have the highest odds of winning The user can specify conditions for providing the one or more rewards to a consumer. The user can specify one or more reward clues. Distinct from good clues that direct a consumer to locate a good or service, reward clues direct a consumer to a reward for finding the goods or services. The one or more reward clues (e.g., a series of rewards clues) can be any information usable by a consumer to locate a reward(s), otherwise qualify to receive a reward, or otherwise qualify to enter into a lottery to receive a reward. For example, a reward clue can be GPS coordinates or partial GPS coordinates, latitude/longitude of varying degrees of precision, a hint as to the location of the reward of varying degrees of precision, a coded message, an image, a video clip, an advertisement, audio, a game, a puzzle, combinations thereof, and the like.

The user can specify whether the one or more rewards are to be provided to the consumer that solves the final reward clue, or whether a plurality of consumers that solve the final reward clue are entered into a lottery to win the one or more rewards. The specified one or more rewards and the one or more conditions can be provided to the lottery subsystem 270 for later processing. The specified one or more reward clues can be provided to the clue management subsystem 220.

Once specified via the campaign subsystem 210, the clue management subsystem 220 can store the one or more good clues and/or the one or more reward clues in a database. The clue management subsystem 220 can be configured to determine the manner in which good clues and/or reward clues are communicated to consumers. The clue management subsystem 220 can determine which good clues and/or reward clues should be sent to which consumer and when. The clue management subsystem 220 can determine a sequence of good clues and/or reward clues to be sent to which consumer and when. The clue management subsystem 220 can be configured to interface with the anti-cheating subsystem 250 and determine a different sequence of good clues and/or reward clues for different consumers. For example, if the anti-cheating subsystem 250 determines that multiple consumers reside in the same house, the clue management subsystem 220 can receive an indication of such from the anti-cheating subsystem 250 and adjust which good clues and/or reward clues are sent to which consumer to avoid the consumers from taking advantage of all consumers having the same good clues and/or reward clues and permitting some consumers to rely one other consumers to solve good clues and/or reward clues. The clue management subsystem 220 can receive a notification from the object recognition subsystem 230 whether an image received from a consumer contains an identified good. The clue management subsystem 220 can determine if the identified good is associated with a good clue and transmit a message to the consumer indicating the result (e.g., successful clue solving or unsuccessful clue solving) along with a reward clue (e.g., “The next digit in the GPS coordinates is 9.”) and either a good clue or a message directed the consumer to the next good. The clue management subsystem can receive an indication from the verification subsystem 240 that an image received from a specific consumer is verified (e.g., was received in compliance with one or more restrictions on the sweepstakes campaign). Once the clue management subsystem 220 has determined that a consumer has successfully solved a clue and that the consumer submission is verified, the clue management subsystem 220 can transmit the next clue to the consumer, either immediately, or on a scheduled/staged release time.

In an aspect, some or all of the functions of the clue management subsystem described herein can be performed by a clue management subsystem 220 resident in the application 290 installed on the mobile device 120. The clue management subsystem 220 resident in the application 290 can receive good clues and reward clues from the clue management subsystem 220 resident in the gaming administrator device 140. In this fashion, the application 290 installed on the mobile device 120 can function in areas with little or no network connectivity. Additionally, the consumer can be presented with good clues and/or reward clues near instantaneously, without requiring communications with the gaming administrator device 140 that could be delayed due to network traffic and/or server load. Any of the subsystems described herein can be operational on either the mobile device 120, the gaming administrator device 140, or both.

As shown in FIG. 2, the clue management subsystem 220 can transmit messages, good clues, and/or reward clues via the network 130 to the mobile device 120. The message can identify the good to the consumer. The good clue can lead the consumer operating the mobile device 120 to identify a consumer good 201 (e.g., a bottle of liquor) as the solution to the clue. The reward clue can give the consumer an indication of how to win and/or locate the reward.

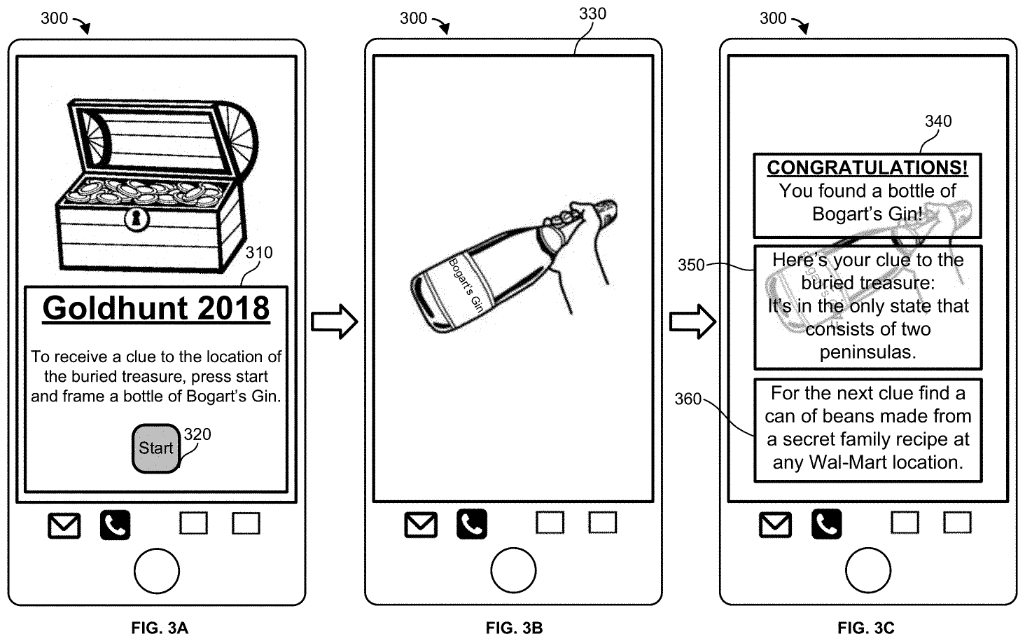

FIG. 3A illustrates an example interface 300 of the application 290 installed on the mobile device 120. The example interface 300 can be configured to provide a message 310 to the consumer. The message 310 can identify a good that the consumer needs to locate in order to receive a reward clue. The consumer can locate the good and engage the start button 320. Engaging the start button 320 causes the application to access a camera of the mobile device 120 as shown in FIG. 3B. The consumer directs a field of view 330 of the camera onto the good and once the good is in the camera's field of view 330, the object recognition subsystem 230 (either resident on the mobile device 120 or resident on the gaming administrator device 140) will recognize the good and make a determination whether the good in the field of view 330 of the camera is correct. As shown in FIG. 3B, if the good is correct, the clue management subsystem 220 (either resident on the mobile device 120 or resident on the gaming administrator device 140) can provide the mobile device 120 with a message 340 indicating that the consumer located the correct good, a good clue 350 that gives the consumer a hint as to the next good to locate, and a reward clue 360 that gives the consumer a hint as to how to win or otherwise collect a reward.

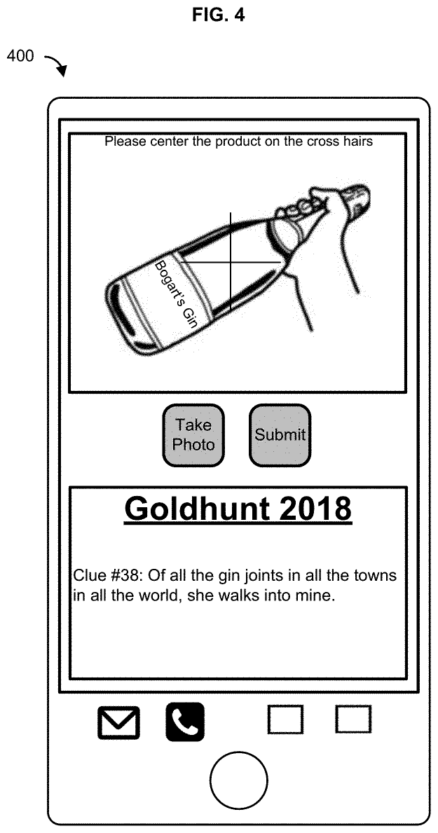

FIG. 4 illustrates an example interface 400 for the mobile device 120 that is configured to provide the clue to the consumer and to enable the consumer to send an image of the solution to the clue back to the gaming administrator device 140 for further processing by the anti-cheating subsystem 250, the object recognition subsystem 230, and/or the verification subsystem 240.

Returning to FIG. 2, once a good is in the field of view of the camera of the mobile device 120 or once an image is received from the mobile device 120 by the gaming administrator device 140, the object recognition subsystem 230 (resident on either the mobile device 120 or the gaming administrator device 140) can determine the object (e.g., the good) depicted in the image. Once determined, an identifier of the good can be provided to one or more of the verification subsystem 240 and/or the clue management subsystem 220 for further processing. The object recognition subsystem 230 can determine the object by providing the image received from the mobile device 120 to an object recognition engine. The object recognition engine can be trained against a library of labeled images. The object recognition engine can comprise an image search tool (e.g., Google® Image Search) and/or a search engine/cognitive service (e.g., Amazon Rekognition, Clarifai, Microsoft Azure Cognitive Services, Google Image Intelligence, Bing®, IBM Watson®, etc.) for analysis. The object recognition engine can analyze the image received from the mobile device 120 by applying computer vision and/or image analysis algorithms to detect the presence of specific persons, objects, brands, logos, text, etc. within the image. If no known objects are found or a known object is found that does not relate to the clue, the gaming administrator device 140 may provide feedback to the consumer that no known objects have been identified or that the object identified is not related to the clue.

In an aspect, some or all of the functions of the object recognition subsystem described herein can be performed by an object recognition subsystem 230 resident in the application 290 installed on the mobile device 120. The object recognition subsystem 230 resident in the application 290 can determine a good in the field of view of a camera of the mobile device 120 or analyze an image of the good taken by the camera of the mobile device 120. In this fashion, the application 290 installed on the mobile device 120 can function in areas with little or no network connectivity. Additionally, the consumer can be presented with feedback regarding whether the good located is correct near instantaneously, without requiring communications with the gaming administrator device 140 that could be delayed due to network traffic and/or server load.

In an aspect, the object recognition subsystem 230 allows for determination/detection/identification of objects (e.g., goods) in one or more images taken by the mobile device(s) 120. This approach generally involves two phases: an offline phase and an online phase. The offline phase includes the creation of a dataset that contains positive images of where a specific good is present and negative images where the specific good is absent. From this dataset a classifier can then be trained, which assigns a probability that the specific good is located at any particular sub-region in an image. The online phase can be used to localize where in the image transmitted by the mobile device 120 the good 190 (e.g., bottle of liquor) is located. In an aspect, the offline phase can be performed by the gaming administrator device 140 and the online phase can be performed by the mobile device 120 to determine objects appearing in the camera field of view of the mobile device 120 or appearing in an image taken with the camera of the mobile device 120.

In an aspect, the object recognition subsystem 230 can identify objects in 2-dimensional images captured by cameras of mobile devices by analyzing properties of the 2-dimensional image. The object recognition subsystem 230 can recognize various properties of the object such as shape, color, label positioning, label text (and subsequent OCR), images present on the object, scannable codes (e.g., QR codes, bar codes, etc.), and the like.

First, object detection can be performed using a series of sliding windows to locate an object (e.g., the good) in the image. There may be many objects present in the image, such as the consumer's hand and arm, other goods, or multiples of the same good. A classifier is trained offline from a training set that contains a variety of images of the good, at a variety of angles, and in a variety of settings (e.g., on a shelf with similar goods, multiples of the same good, being held by a consumer, different lighting, etc.). A negative sample set that spans this variation can be included in the training set. The negative samples can be generated using randomly cropped patches that contain the same amount of structure (edges, line thickness) as the positive samples, but which do not contain the full good and/or contain other goods.

After the dataset is created, a classifier can be trained using one or more machine learning algorithms. In this operation, first a set of features can be extracted from both the positive and negative samples in the offline phase. The extracted features can then be employed to train a classifier to distinguish the good from other goods. The extracted features may include one or more of, for example, Fisher Vector, Histogram of Oriented Gradients (HOG), Harris corners, Local Binary Patterns (LBP), among others. The classifier trained using the extracted features can be, for example, one of the following: support vector machines (SVM), k-nearest neighbor (KNN), neural networks (NN), or convolutional neural networks (CNN), etc.

Artificial neural networks are computational tools capable of machine learning. In artificial neural networks, which will be referred to as neural networks hereinafter, interconnected computation units known as “neurons” are allowed to adapt to training data, and subsequently work together to produce predictions in a model that to some extent resembles processing in biological neural networks. Neural networks may comprise a set of layers, the first one being an input layer configured to receive an input. The input layer comprises neurons that are connected to neurons comprised in a second layer, which may be referred to as a hidden layer. Neurons of the hidden layer may be connected to a further hidden layer, or an output layer. In some neural networks, each neuron of a layer has a connection to each neuron in a following layer. Such neural networks are known as fully connected networks. The training data is used to let each connection to assume a weight that characterizes a strength of the connection. Some neural networks comprise both fully connected layers and layers that are not fully connected. Fully connected layers in a convolutional neural network may be referred to as densely connected layers. In some neural networks, signals propagate from the input layer to the output layer strictly in one way, meaning that no connections exist that propagate back toward the input layer. Such neural networks are known as feed forward neural networks. In case connections propagating back toward the input layer do exist, the neural network in question may be referred to as a recurrent neural network. Convolutional neural networks, CNN, are feed-forward neural networks that comprise layers that are not fully connected. In CNNs, neurons in a convolutional layer are connected to neurons in a subset, or neighborhood, of an earlier layer. This enables, in at least some CNNs, retaining spatial features in the input.

It can be appreciated these are mere examples of possible classifiers that can be adapted for use with the disclosed embodiments, and that other types of classifiers may also be employed in the context of the disclosed embodiments. That is, the disclosed embodiments are not limited to such example classifier types.

In the operational phase, given an image, a series of sliding window searches can be performed using the classifier trained in the offline phase to locate potential label text in the image. A set of candidate windows can then be identified using a non-maximum suppression technique. The locations with the largest scores are candidates for the label text and are examined in descending order. The window that best matched the size and aspect ratio of the label text can be used for OCR. After OCR, the object recognition subsystem 230 can compare the OCR label text to a database of text from the label to determine if the scanned text matches the good associated with the clue.

In another aspect, the object recognition subsystem 230 can identify a 3-dimensional (3D) shape of an object in 2-dimensional images captured by cameras of mobile devices. In an aspect, the object recognition subsystem 230 determine a 3D shape from images of objects belonging to a certain class. This 3D reconstruction can be performed by establishing a statistical shape model, denoted the feature model, that 3D positions. Such a model is learned, e.g., the model parameters are estimated, from training data where the 2D-3D correspondence is known. This learning phase may be done using any appropriate system for obtaining such 2D-3D correspondence, including, but not limited to binocular or multi-view image acquisition systems, range scanners or similar setups. In this process the object of interest is measured and a reference model of the object is obtained which may be used in subsequent image analysis as will be described below.

Given an input image, the process of recovering the 3D shape is a two-step procedure. First the image features such as points, curves and contours are found in the images e.g. using techniques such as e.g. Active Shape Models (ASM) or gradient based methods or classifiers such as SVM. Then the 3D shape is inferred using the learned feature model. There is also the option of extending the 3D shape representation from curves and points to a full surface model by fitting a surface to the 3D data.

Generation of the feature model is described. Assume a number of elements in a d-dimensional vector t, for example, a collection of 3D points in some normalized coordinate system. The starting point for the derivation of the model is that the elements in t can be related to some latent vector u of dimension q where the relationship is linear:

t=Wu+μ (1)

where W is a matrix of size d×q and μ is a d-vector allowing for non-zero mean. Once the model parameters W and ,u have been learned from examples, they are kept fixed. However, measurements take place in the images, which usually is a non-linear function of the 3D features according to the projection model for the relevant imaging device.

Denote the projection function with f: R^{d}→R^{e}, projecting all 3D features to 2D image features, for one or more images. Also, the coordinate system of the 3D features can be changed to suit the actual projection function. Denote this mapping by T: R^{d}→R^{d}. Typically, T is a similarity transformation of the world coordinate system. Thus, f(T(t)) will project all normalized 3D data to all images. Finally, a noise model needs to be specified. Assume that the image measurements are independent and normally distributed, likewise, the latent variables are assumed to be Gaussian with unit variance u˜N(0,I). Thus, in summary:

t_{2D}=f(T(t))+ε=f(T(Wu+μ))+ε (2)

where ε˜N(0, σ² I) for some scalar σ.

Before the model can be used, its parameters need to be estimated from training data. Given that it is a probabilistic model, this is can be done with maximum likelihood (ML). Assume n examples {t_{2D,i}}ᵢ₌₁ⁿ, the ML estimate for W and μ is obtained by minimizing:

$${\sum }_{i = 1}^{n} ( \frac{1}{{σ}^{2}} {‖ {t}_{2 D} - f ( {T}_{i} ( {u}_{i} ) ) ‖}^{2} + {‖ {u}_{i} ‖}^{2} \qquad ( 3 )$$

over all unknowns. The standard deviation σ is estimated a priori from the data. Once the model parameters W and ,u have been learned from examples, they are kept fixed. In practice, to minimize (3) the methods can alternatively optimize over (W, μ) and {uᵢ}ᵢ₌₁ⁿ using gradient descent. Initial estimates can be obtained by intersecting 3D structure from each set of images and then applying PPCA algorithms for the linear part. The normalization Tᵢ(.) is chosen such that each normalized 3D sample has zero mean and unit variance.

There are three different types of geometric features embedded in the model, points, curves, and apparent contours. Points: A 3D point which is visible in m>1 images will be represented in the vector t with its 3D coordinates (X,Y,Z). For points visible in only one image, m=1, no depth information is available, and such points are represented similarly to apparent contour points. Curves: A curve will be represented in the model by a number of points along the curve. In the training of the model, it is important to parameterize each 3D curve such that each point on the curve approximately corresponds to the same point on the corresponding curve in the other examples. Apparent contours: As for curves, we sample the apparent contours (in the images). However, there is no 3D information available for the apparent contours as they are view-dependent. A simple way is to treat points of the apparent contours as 3D points with a constant, approximate (but crude) depth estimate.

Finding Image Features

In the on-line event of a new input sample, we want to automatically find the latent variables u and, in turn, compute estimates of the 3D features t. The missing component in the model is the relationship between 2D image features and the underlying grey-level (or color) values at these pixels. There are several ways of solving this, e.g. using an ASM (denoted the grey-level model) or detector based approaches.

The Grey-Level Model

Again, we adopt a linear model (PPCA). Using the same notation as in (1), but now with the subscript gl for grey-level, the model can be written

t_{gl}=W_{gl}u_{gl}+μ_{gl}+ε_{gl} (4)

where t_{gl} is a vector containing the grey-level values of all the 2D image features and ε_{gl} is Gaussian noise in the measurements. In the training phase, each data sample of grey-levels is normalized by subtracting the mean and scaling to unit variance. The ML-estimate of W_{gl} and μ_{gl} is computed with the EM-algorithm [5].

Detector-Based Methods

Image interest points and curves can be found by analyzing the image gradient using e.g. the Harris corner-detector. Also, specially designed filters can be used as detectors for image features. By designing the filters so that the response for certain local image structures are high, image features can be found using a 2D convolution.

Classification Methods

Using classifiers such as SVM, image regions can be classified as corresponding to a certain feature or not. By combining a series of such classifiers, one for each image feature (points, curves, contours etc.) and scanning the image at all appropriate scales the image features can be extracted. Examples can be e.g. an eye detector for facial images.

Deformable Models

Using a deformable model such as the Active Contour Models, also called snakes, of a certain image feature is very common in the field of image segmentation. Usually the features are curves. The process is iterative and tries to optimize an energy function. An initial curve is deformed gradually to the best fit according to an energy function that may contain terms regulating the smoothness of the fit as well as other properties of the curve.

Surface Fitting to the 3D Data

Once the 3D data is recovered, a surface model can be fitted to the 3D structure. This might be desirable in case the two-step procedure above only produces a sparse set of features in 3D space such as e.g. points and space curves. Even if these cues are characteristic for a particular sample (or individual), it is often not enough to infer a complete surface model, and in particular, this is difficult in the regions where the features are sparse. Therefore, a 3D surface model consisting of the complete mean surface is introduced. This will serve as a domain-specific, i.e. specific for a certain class of objects, regularizer. This approach requires that there is dense 3D shape information available for some training examples in the training data of the object class obtained from e.g. laser scans or in the case of medical images from e.g. MRI or computer tomography. From these dense 3D shapes, a model can be built separate from the feature model above. This means that, given recovered 3D shape, in the form of points and curves, from the feature model, the best dense shape according to the recovered 3D shape can be computed. This dense shape information can be used to improve surface fitting.

To illustrate with an example, consider the case of the object class being bottles. The model is then learned using e.g., points, curves, and contours in images together with the true 3D shape corresponding to these features obtained from e.g., multi-view stereo techniques. A second model is then created and learned using e.g., laser scans of bottles, giving a set of bottle surfaces. This second model can be used to find the most probable (or at least highly probable) mean bottle surface (according to the second model) corresponding to the features or the recovered 3D shape. A surface can then be fitted to the 3D shape with the additional condition that where there is no recovered 3D shape, the surface should resemble the most probable mean bottle surface. The methods described provide the most probable or an at least highly probable 3D shape.

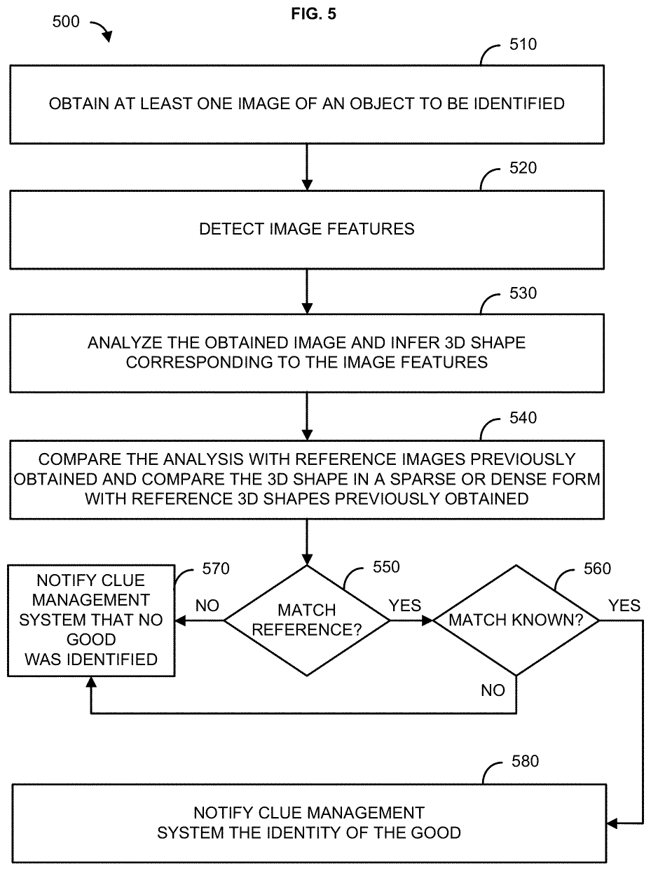

A method 500 for object recognition may be illustrated using FIG. 5. The method 500 can comprise obtaining at least one image of an object to be identified at 510. The method 500 can comprise detecting image features, such as curves, points, and apparent contours at 520. The method 500 can comprise analyzing the obtained image and inferring 3D shape corresponding to the image features, using a statistical shape model at 530. The method 500 can comprise comparing the analysis with reference images previously obtained and comparing the 3D shape in a sparse or dense form with reference 3D shapes previously obtained at 540. The method 500 can comprise determining if the 3D shape matches any reference images process at 550. If the 3D shape matches a reference image, the method 500 can determine if the reference image corresponds to a known good at 560. If the 3D shape does not match a reference image, a notification can be sent to the clue management subsystem 220 that no good was identified at 570. If the reference image corresponds to a known good, a notification can be sent to the clue management subsystem 220 that identifies the good at 580.

Returning to FIG. 2, the verification subsystem 240 can be configured to verify that an image received is from an authorized consumer. The verification subsystem 240 can be configured to verify that received images are authentic. The verification subsystem 240 can be configured to receive information associated with an image received from the mobile device 120, such as an identifier associated with the mobile device 120 (e.g., IMSI, IMEI, IP address, phone number, username, and the like), temporal information associated with the content (e.g., a timestamp, a time offset, a time window, a start time, an end time, etc.), location information (e.g., address, coordinates (e.g., Cartesian coordinates, etc.) associated with a frame of the content, any other information (e.g., metadata, content parameters, content settings, etc.), combinations thereof, and the like. The verification subsystem 240 can use such information to enforce one or more restrictions specified through the campaign subsystem 210.

As described with regard to FIG. 3A, FIG. 3B, FIG. 3C, and FIG. 4, once a consumer has identified what the consumer believes to be a good that solves a clue, the consumer can use an application installed on a mobile device 120 to scan the good or to take a picture of the good. The resulting image can be transmitted to a nearest gaming administrator device 140 or processed locally by the mobile device 120. In order to transfer the image to the gaming administrator device 140, the mobile device 120 must access one or more networks 130 in order to communicate with and receive data from the gaming administrator device 140. The consumer may enter relevant personal information into the application installed on the mobile device 120 such as, for example, name, age, gender, home address, username, password, referral code, phone number, loyalty program, etc., which is sent to the gaming administrator device 140 via the one or more networks 130 and stored in a memory of one or more gaming administrator device 140. This personal information may be retrieved at a later time for various reasons. After submission of the personal information, verification subsystem 240 verifies authenticity of the user's information and the consumer's mobile device 120.

The consumer's information and mobile device may be authenticated in a variety of different manners and at a variety of different times such as, for example, during account creation, during location declaration, during taking of a photograph of a good, before, during, or after consumer activity, during purchases, during value redemption, etc. The following example embodiments of authentication are for illustrative and example purposes and are not intended to be limiting. Other authentication embodiments are possible and are intended to be within the spirit and scope of the disclosed example embodiments.

In one example embodiment, verification may be transparent to the consumer such that verification occurs without their active involvement. In other words, information transfer and verification occurs in the background. For example, upon establishing communication between the mobile device 120 and the one or more gaming administrator devices 140 via the one or more networks 130, the one or more gaming administrator devices 140 may communicate with the consumer's mobile device 120 to verify that the device is authentic. Various types of background verifying communication may occur between the one or more gaming administrator devices 140 and the mobile device 120. These may include communications relying on an active connection to a mobile telecommunication carrier's network to ensure that the mobile device 120 is active, unique, and corresponds with the identifying information provided by the consumer. For example, a push notification or short message service (SMS) may be sent to the mobile device 120 using its device token, IMEI, IMSI, UDID, telephone number, telephony ID, MAC address, etc. This allows verification via a unique identifier on the network. It also eliminates multiple accounts on a verified mobile device 120 and permits permanent banning of fraudulent accounts. This verification enables banning of a particular mobile device 120.

In another example embodiment, upon establishing communication between the mobile device 120 and the one or more gaming administrator devices 140 via one or more networks 130, the one or more gaming administrator devices 140 may send a communication to the mobile device 120 that is displayed on the mobile device 120 and requires a response from the consumer. Such communications may include, but are not limited to, emails, short message service (SMS) communications such as text messages, or any other type of communication. In such example embodiments, a challenge activity may be presented to the consumer and the consumer must respond in a particular manner in order for the mobile device 120 to be authenticated. For example, the consumer may be required to answer a question, input a passcode, take a picture of himself/herself, take a picture of a particular item, scan a barcode that may be recorded for future verification via automated or manual methods, etc. If the consumer responds properly, then the mobile device 120 is authenticated and may be used in accordance with the disclosed example embodiments. If the consumer responds improperly or does not respond, the mobile device 120 is not authenticated and any images received from the mobile device 120 will be rejected until such time that the mobile device 120 is authenticated.

In yet another example embodiment, upon establishing communication between the mobile device 120 and the one or more gaming administrator devices 140 via the one or more networks 130, the one or more gaming administrator devices 140 may send an automated telephone call to the mobile device 120 or an individual may place a manual call to the mobile device 120 (e.g., if the mobile device 120 is enabled for telephone communication). The consumer is required to respond to the automated or manual telephone call in a particular manner in order for the mobile device 120 to be authenticated. For example, the consumer may be required to answer a question, provide additional information, enter a code, etc. If the consumer provides a proper response, then the mobile device is authenticated and may be used in accordance with the disclosed example embodiments. If the consumer provides an improper response or the telephone call is not answered, the mobile device is not authenticated and may not be used in accordance with the disclosed example embodiments until such time that it is authenticated. If a mobile device 120 cannot be authenticated, a notification can be sent to the anti-cheating subsystem 250 to flag the account associated with the unauthenticated mobile device.

In a further example embodiment, the consumer may be required to use an authenticator. The authenticator can generate a modulating unpredictable, non-repeated communication or code that the consumer is required to enter before the mobile device 120 can be authenticated. The verification subsystem 240 can utilize a duplicate of the authenticator that generates the same communication or code as the authenticator installed on the mobile device 120 and is used to confirm a matching code, resulting in a verified mobile device 120.

Once the consumer and/or mobile device 120 are verified by the verification subsystem 240. Any images submitted by the consumer and/or mobile device 120 to the gaming administrator device 140 can be authenticated and validated. The verification subsystem 240 can be configured for authenticating and validating still images and videos (imagery) captured by the mobile device 120 or other digital camera device. The verification subsystem 240 not only enables detection of image tampering, but also enables verification of the time the image was taken, its location, and other information that may be used to determine the authenticity and validity of the imagery.

The verification subsystem 240 can be configured to receive and use metadata (and other information) associated with the image to authenticate and verify the images and videos, and to protect the metadata by public/private key encryption. The metadata may include not only time and date, but also other data such as camera settings (aperture, shutter speed, focal length, and so forth), camera orientation and movement data, and context information such as sounds or words captured contemporaneously with the image, the direction in which the image is taken, and signals from nearby cell towers or WiFi hotspots.

The image itself can be watermarked with a unique identifier that is embedded in the image using a symmetric key generated by the application installed on the mobile device 120, and the watermarked image, metadata, and symmetric key are digitally signed and uploaded or transmitted to verification subsystem 240 for processing by the object recognition subsystem 230 upon authentication of the digital signatures of the watermarked image, metadata, and symmetric key.

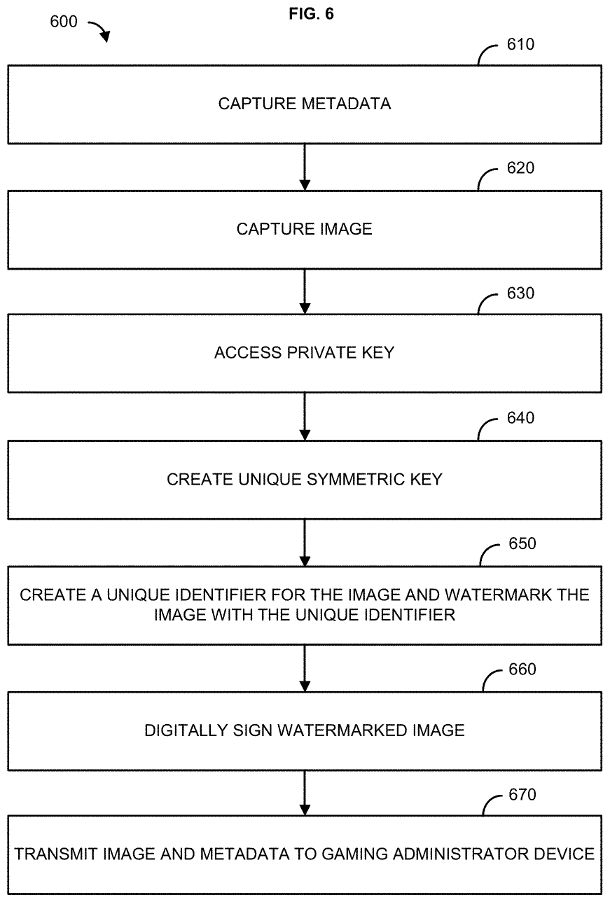

As illustrated in FIG. 6, a method 600 for image verification is described that begins when the consumer wishes to submit an image, either in the form of a still image or video, to gaming administrator device 140 and thereby the verification subsystem 240, for example by selecting and opening the application installed on the mobile device 120, taking a photo of a good, and engaging the submit button to submit the image to the gaming administrator device 140.

At step 610, the application captures metadata. The more different types of metadata captured, the greater the confidence will be in subsequent image validation, and therefore the following list of metadata that the application may be designed to capture, or that may be available to the application for optional or selective capture, is not intended to be exhaustive. Instead, the term “metadata” as used herein is intended to encompass all possible data that may be captured at the time of image capture and that is potentially relevant to the authenticity of validity of the captured image, including any or all of the following position, time, camera orientation, mobile device velocity, shake/rattle/roll (SRR) of the mobile device, audio, network tower and nearby by WiFi identification, system state and processes record, EXIF-like data, combinations thereof, and the like.

Position data can comprise GPS position information derived from the mobile device's 120 GPS antenna and chipset, assisted GPS data (A-GPS data) from the cellular network servers giving current satellite ephemeris and time information directly to the mobile device 120 via the cellular network or via a WiFi connection, and data from the mobile device's 120 accelerometers. Because the GPS satellite data rate to a mobile device 120 is low (50 bps), standalone GPS can take a long time to download the current GPS almanac and ephemeris data needed to get a first fix when the GPS has been off. The cellular network can substantially reduce this first fix time because it continuously downloads and can provide this current GPS almanac and ephemeris data directly to the mobile device 120.

The mobile device 120 accelerometers provide the instantaneous motion of the mobile device 120. This motion information enables the computation of the change in the mobile device's 120 position with time. When GPS goes down, for example as a result of obstructions to the GPS signal from buildings, foliage and landscape, the accelerometers can re-compute position from the last known position until GPS comes back up.

Since the location where the image is captured will often be a critical part of the authenticability of the image, providing a “well-grounded” estimate of position is important, e.g., the estimate should be the most accurate measure of position over the largest portion of the time interval of the imaging action, as is possible for the mobile device 120 to obtain. The verification subsystem 240 can determine if a location restriction has been applied via the campaign subsystem 210, and if so, whether an image was taken at an authorized location. If the image was not taken at an authorized location, the verification subsystem 240 can send a notification to the anti-cheating subsystem 250 or any other subsystem.

Date and time data may be taken from the cellular network, from the GPS satellite data, from NIST's FM signal, from any of several internet sites, or if no connectivity is available to access these services, then from the mobile device 120 internal clock that can accurately compute change of time since the last known time. Like position, the date and time that an image was taken can be a critical factor in the authenticability of an image. If the image was not taken at an authorized location, the verification subsystem 240 can send a notification to the anti-cheating subsystem 250 or any other subsystem.

Live gyro data and live accelerometer data can be used together to compute the a mobile device 120 orientation, e.g., where the camera's lens is pointing, as a function of time. The origination can be stored as camera orientation data. Computed orientation can be stored as a table with the elevation and azimuth of the vector normal to the mobile device's 120 face (or the vector normal to the back if with respect to the back facing mobile device's 120 lens).

By determining the position of the center of gravity (CG) of the mobile device 120, the live gyro data and live accelerometer data can also be used to compute the mobile device 120 velocity vector, that is the instantaneous direction of translation of the mobile device 120 CG, as a function of time. The velocity vector measures how the mobile device 120 is translating through space. For a mobile device 120, movement is probably best understood in terms of speed, change in elevation if any, and change in azimuth (compass heading,) if any. Speed can be used to determine whether the consumer using the mobile device 120 was stationary, moving on foot, moving at car speed, or flying during the time period of the imaging event.

The shake/rattle/roll (SRR) of the mobile device 120 is the set of high frequency movements arising from jostling, handling or even dropping the mobile device 120. Like orientation and velocity, SRR is calculated from the live gyro and accelerometer data. Six elements make up SRR and can be calculated via three rotational movements roll, pitch, and yaw, and three translational movements X, Y and Z (the X-axis being the East-West axis, the Y-axis being the North-South axis, and the Z-axis being the up-down axis). From SRR data, the verification subsystem 240 can determine such things as whether the consumer is running, walking, going up or down stairs, jumping, and the like, during the imaging event.

When the consumer engages the application installed on the mobile device 120 to capture an image, the application may begin recording audio via one or more microphones of the mobile device 120.

Network tower and nearby WiFi identification data can be stored that represents the identification of the network towers and the WiFi transmitters nearby the mobile device 120 that are identifiable by the mobile device 120.

Exchangeable Image File Format (Exif)-like data can comprise camera identification information, imaging settings, and image processing information that characterizes the image that is collected during the imaging action. This information may include any or all of the image creation date, creation time, dimensions, exposure time, image quality or resolution, aperture, color mode, flash used, focal length, ISO equivalent, image format (e.g., jpeg) process, camera manufacturer, metering mode, camera model, and image orientation.

When the consumer engages the application installed on the mobile device 120 to capture an image, the application may make a record of other applications and/or processes running on the mobile device 120. Other applications and/or processes could interfere with, tamper with or spoof the validity of the image being produced.

Returning to FIG. 6, at step 620, which may occur before, during, and/or after metadata capture step 620, the mobile device 120 can capture an image of a good. Optionally, the method 600 can further comprise blocking access to other processes and/or applications on the mobile device 120 that would interfere any other step of the method 600 (which may occur before, during, or after image capture step 620). Once the image is captured by imaging sensors in the mobile device 120, it is digitized and formatted to generate the image. However, Exif data should be considered as part of the metadata that may be captured, and this step may be performed at any time that the data becomes available to the application.

At step 630, a private key can be accessed. Step 630 may be performed at any time before the private key is needed for digital signature generation, as described below. The private key can be obtained from the verification subsystem 240 or a third party key server. Any private key or key obtaining/storing method may be utilized.

The method 600 continues to step 640 to create a unique symmetric key for each imaging action, e.g., for each photo taken or image made. The unique symmetric key, also known as a session key, may be a random number by a random number generator or algorithm in the mobile device 120, or any number or value derived from a changing and/or arbitrary input or sensed value, or a combination thereof.

This symmetric key can then be used in step 650 to create a unique identifier for the image, and the image then is watermarked with the unique identifier. The unique identifier may comprise the symmetric key itself, a concatenation of the symmetric key and other information, and/or a code or information (such as metadata) encrypted by the symmetric key, or the symmetric key may be used as part of a more involved process that embeds the unique identifier in the image. The symmetric key is saved for forwarding to the verification subsystem 240 together with the watermarked image and the metadata, as described below. For example, instead of embedding the unique identifier throughout the image, the unique identifier may be used as a key for finding a hidden watermark through the captured image.

Optionally, a quick reference number (QRN) may also be assigned to the image for easy tracking of a particular image within the mobile device 120 and after the image is uploaded to the verification subsystem 240. The quick reference number may be hidden and/or applied to watermark the image so that it can be used by the verification subsystem 240 as an additional validation code, or non-obfuscated and placed on a logo or other mark to identify the image to any third party as being protected and available for authentication and validation from the verification subsystem 240 based on the quick reference number. The watermarked image may then be stored on the mobile device 120 for subsequent retrieval, or immediately processed for uploading to the verification subsystem 240.

At step 660, the watermarked image can be digitally signed so that the image can be authenticated by the verification subsystem 240 after transmission or uploading. The digital signature may be obtained by encrypting the watermarked image or a portion thereof using the private key of a private/public key cryptosystem. This ensures that the image has been encrypted by a registered consumer whose identity is known to the verification subsystem 240, as described below, because decryption can only be successfully carried out using the public key held by the verification subsystem 240 if the image was encrypted by a unique private key that corresponds to the public key. Encryption techniques other than private/public key encryption may be used to authenticate the image. In addition to the digitally-signed watermarked digital image, the metadata and the symmetric key can be digitally signed and sent to the verification subsystem 240 so that the metadata can be authenticated.

The signed encrypted image and/or encrypted metadata can be transmitted to the verification subsystem 240 at step 670. The transmission/upload can utilize a secured communications channel. Upon completion of the transmission/upload, the image capture and procedure on the mobile device 120 may be terminated.

Prior to any upload, the consumer must be registered with the gaming administrator device 140, so that the verification subsystem 240 will recognize the identity of the consumer and be able to associate the correct keys with the received image. The consumer may be identified by any combination of unique identification number of the consumer's device, a username password, and/or other consumer identifying data such as biometric identification data such as a finger or voice print. At the time of registration, or before any image capture using the method and system of the invention, a private key unique to the consumer must be supplied to the consumer via the application installed on the mobile device 120 and, if originating with a third party key server, a corresponding public key supplied to the verification subsystem 240.

The verification subsystem 240 can receive the signed image, metadata, and symmetric key. The verification subsystem 240 authenticates the received watermarked image, metadata, and symmetric key by decrypting the digital signatures using the public key corresponding to the consumer's private key, and comparing the information extracted from the decrypted digital signature with corresponding information transmitted by the consumer. The symmetric key can then be used to encrypt the image and metadata for storage on the gaming administrator device 140. When the signed image, metadata, and symmetric key is received from a registered mobile device 120, the verification subsystem 240 can retrieve an identifier of the mobile device 120 to retrieve the public key associated with the private key of the mobile device consumer account. The verification subsystem 240 can use the public key to confirm that the metadata digital signature and the image digital signature collected for the imaging action are valid. The verification subsystem 240 can retrieve the symmetric key and decrypt the image and/or data using the associated public key belonging to the device user account.

Returning to FIG. 2, the verification subsystem 240 can provide the decrypted image to the object recognition subsystem 230 for further processing. The verification subsystem 240 can provide some or all the metadata to any other subsystem, including the anti-cheating subsystem 250 and/or the behavior analysis subsystem 280.

The anti-cheating subsystem 250 can be configured to identify patterns in metadata associated with a single consumer and across multiple consumers that is indicative of cheating. The anti-cheating subsystem 250 can determine if a location discrepancy exists with regard to an image submission. The anti-cheating subsystem 250 can receive a notification from the verification subsystem 240 that an image was not taken at a location approved via the campaign subsystem 210. The anti-cheating subsystem 250 can determine if a timing discrepancy exists with regard to an image submission. The anti-cheating subsystem 250 can receive a notification from the verification subsystem 240 that an image was not taken at within a timeframe approved via the campaign subsystem 210. The anti-cheating subsystem 250 can track such notifications over time for any given consumer or group of consumers and determine if a pattern indicative of cheating exists. The anti-cheating subsystem 250 can mine metadata to determine if multiple users are submitting the same image, or an image of the same good. The anti-cheating subsystem 250 can determine if the same device is submitting multiple entries under different consumer accounts. The anti-cheating subsystem 250 can ban consumers temporarily or permanently, and can issue warnings to consumers.

The gaming administrator device 140 can comprise a blockchain subsystem 260. The blockchain subsystem 260 can be used to store verified, successful solves of a clue for a given consumer. Blockchain technology was developed as a way of providing a publicly transparent and decentralized ledger that is configured to track and store digital transactions in a publicly verifiable, secure, and hardened manner to prevent tampering or revision.

A typical blockchain includes three primary functions: read, write, and validate. For example, a user of the blockchain must have the ability to read the data that resides on the blockchain. A user of the blockchain must also have the ability to write, e.g. append, data to the blockchain. Every write operation starts out as a proposed transaction that is posted on the network. The proposed transaction may not always be valid, for example, it may be malformed (syntax errors), or it may constitute an attempt to perform a task for which the submitter is not authorized. Validation refers to filtering out invalid transactions and then deciding on the exact order for the remaining, valid, transactions to be appended to the blockchain as part of a new block.

Once ordered, the transactions are packaged into a new block, and the new block is voted on by the validator nodes associated with the blockchain to determine whether to add the new block to the blockchain. If a consensus to add the new block is reached, e.g., a threshold number of “for” votes, the new block may be appended to the blockchain. Each new block that is appended to the blockchain also includes a hash of the previous block. Accordingly, as each new block is added, the security and integrity of the entire blockchain is further enhanced. It is important to note that once data is written to the blockchain, for example, once a block including a set of transactions has been appended to the blockchain, that data can no longer be altered or modified. In a typical blockchain, the anonymity of the users is protected through the use of pseudonyms and the transaction data itself is protected through the use of cryptography, e.g., via the use of hash codes.

The gaming administrator device 140 can comprise a lottery subsystem 270. The lottery subsystem 270 can be configured to determine a winning consumer from a group of consumers that have solved clues. In the event the sweepstakes campaign is configured to award one or more consumers from a group of consumers that solved clues, the lottery subsystem 270 can be configured to randomly select the winning consumers.

The gaming administrator device 140 can comprise a behavior analysis subsystem 280. The behavior analysis subsystem 280 can be configured to analyze the various metadata collected via the application installed on the mobile device 120. The behavior analysis subsystem 280 can be configured to mine the various metadata stored by the application installed on the mobile device 120 as part of an image capture and/or as part of a consumer authorized monitoring of user behaviors, including locations, travel, purchases, and the like.

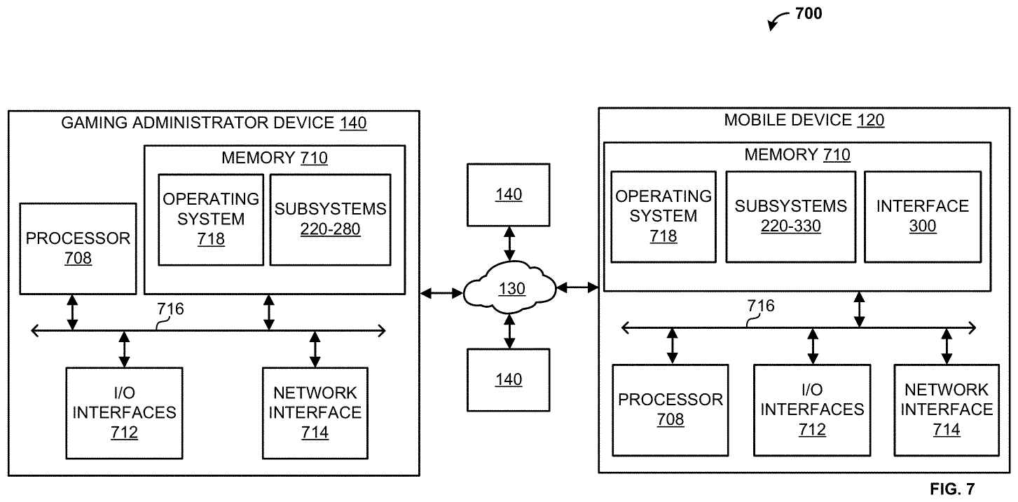

FIG. 7 is a block diagram depicting an environment 700 comprising non-limiting examples of a server 702 (e.g., gaming administrator device) and a client 706 (e.g., mobile device) connected through a network 704. The server 702 can comprise one or multiple computers configured to store one or more of the various subsystems 210-280. The client 706 can comprise one or multiple computers configured to operate a user interface (e.g., the user interface 300) such as, for example, a smartphone. Multiple clients 706 can connect to the server(s) 702 through a network 704 such as, for example, the Internet or any wired or wireless connection.

The server 702 and the client 706 can be a digital computer that, in terms of hardware architecture, generally includes a processor 708, memory system 710 (e.g., the memory 310), input/output (I/O) interfaces 712, and network interfaces 714. These components (708, 710, 712, and 714) are communicatively coupled via a local interface 716. The local interface 716 can be, for example but not limited to, one or more buses or other wired or wireless connections, as is known in the art. The local interface 716 can have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 708 can be a hardware device for executing software, particularly that stored in memory system 710. The processor 708 can be any custom made or commercially available processor, a central processing unit (CPU), an auxiliary processor among several processors associated with the server 702 and the client 706, a semiconductor-based microprocessor (in the form of a microchip or chip set), or generally any device for executing software instructions. When the server 702 or the client 706 is in operation, the processor 708 can be configured to execute software stored within the memory system 710, to communicate data to and from the memory system 710, and to generally control operations of the server 702 and the client 706 pursuant to the software.

The I/O interfaces 712 can be used to receive user input from and/or for providing system output to one or more devices or components. User input can be provided via, for example, a keyboard and/or a mouse. System output can be provided via a display device and a printer (not shown). I/O interfaces 712 can include, for example, a serial port, a parallel port, a Small Computer System Interface (SCSI), an IR interface, an RF interface, and/or a universal serial bus (USB) interface.

The network interface 714 can be used to transmit and receive from an external server 702 or a client 706 on a network 704. The network interface 714 may include, for example, a 10BaseT Ethernet Adaptor, a 100BaseT Ethernet Adaptor, a LAN PHY Ethernet Adaptor, a Token Ring Adaptor, a wireless network adapter (e.g., WiFi), or any other suitable network interface device. The network interface 714 may include address, control, and/or data connections to enable appropriate communications on the network 704.

The memory system 710 can include any one or combination of volatile memory elements (e.g., random access memory (RAM, such as DRAM, SRAM, SDRAM, etc.)) and nonvolatile memory elements (e.g., ROM, hard drive, tape, CDROM, DVDROM, etc.). Moreover, the memory system 710 may incorporate electronic, magnetic, optical, and/or other types of storage media. Note that the memory system 710 can have a distributed architecture, where various components are situated remote from one another, but can be accessed by the processor 708.

The software in memory system 710 may include one or more software programs, each of which comprises an ordered listing of executable instructions for implementing logical functions. In the example of FIG. 7, the software in the memory system 710 of the server 702 can comprise one or more of the subsystems 210-280 and a suitable operating system (O/S) 718. In the example of FIG. 7, the software in the memory system 710 of the client 706 can comprise one or more of the subsystems 210-280, the user interface 300, and a suitable operating system (O/S) 718. The operating system 718 essentially controls the execution of other computer programs, such as the operating system 718, the user interface 300, and provides scheduling, input-output control, file and data management, memory management, and communication control and related services.

For purposes of illustration, application programs and other executable program components such as the operating system 718 are illustrated herein as discrete blocks, although it is recognized that such programs and components can reside at various times in different storage components of the server 702 and/or the client 706. An implementation of the subsystems 210-280 and/or the user interface 300 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” can comprise volatile and non-volatile, removable and non-removable media implemented in any methods or technology for storage of information such as computer readable instructions, data structures, program modules, or other data. Exemplary computer storage media can comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method comprising:
receiving one or more clues related to a consumer good;
transmitting the one or more clues to one or more consumer mobile devices;
in response to transmitting the one or more clues, receiving, from at least one of the one or more consumer mobile devices, an image and metadata associated with the image;
determining that the image is a solution to the one or more clues; and
providing another clue to the at least one of the one or more consumer devices.

2. The method of claim 1, wherein determining that the image is a solution to the one or more clues comprises determining an object present in the image.

3. The method of claim 2, further comprising:
determining that the image is a solution to the one or more clues that the object matches a reference object, wherein the reference object represents the solution to the clue.

4. The method of claim 3, further comprising generating a three dimensional representation of the object.

5. The method of claim 4, wherein determining that the image is a solution to the one or more clues that the object matches a reference object comprises determining that the three dimensional representation of the object matches a three dimensional reference object.

6. The method of claim 5, wherein the three dimensional representation of the object is determined to match the three dimensional reference object using a machine learning model.

7. The method of claim 6, wherein the machine learning model comprises one or more of a support vector machine, a k-nearest neighbor algorithm, a neural network, or a convolutional neural network.

8. A sweepstakes campaign system comprising:
a gaming administrator device, configured to:
receive one or more clues related to a consumer good;
transmit the one or more clues to one or more consumer mobile devices;
in response to transmitting the one or more clues, receive, from at least one of the one or more consumer mobile devices, an image and metadata associated with the image;
determine that the image is a solution to the one or more clues; and
provide another clue to the at least one of the one or more consumer devices; and
an application installed on a consumer mobile device configured to:
receive the one or more clues;
capture the image of the consumer good;
capture the metadata; and
transmit the image and the metadata to the gaming administrator device.

9. The system of claim 8, wherein the gaming administrator device is configured to determine that the image is a solution to the one or more clues by determining an object present in the image.

10. The system of claim 9, wherein the gaming administrator device is further configured to:
determine that the image is a solution to the one or more clues that the object matches a reference object, wherein the reference object represents the solution to the clue.

11. The system of claim 10, wherein the gaming administrator device is further configured to:
generate a three dimensional representation of the object.

12. The system of claim 11, wherein the gaming administrator device is configured to determine that the image is a solution to the one or more clues that the object matches a reference object by determining that the three dimensional representation of the object matches a three dimensional reference object.

13. The system of claim 12, wherein the gaming administrator device determines that the three dimensional representation of the object matches the three dimensional reference object using a machine learning model.

14. The system of claim 13, wherein the machine learning model comprises one or more of a support vector machine, a k-nearest neighbor algorithm, a neural network, or a convolutional neural network.

15. A method comprising:
receiving, by a computing device, metadata associated with an image captured by the computing device;
determining, based on a symmetric key, an identifier for the image;
generating, based on the metadata associated with the image and the identifier, a watermarked image; and
sending, to a verification subsystem, the watermarked image, wherein the verification subsystem determines, based on the watermarked image, that the metadata identifies the computing device.

16. The method of claim 15, wherein the metadata comprises one or more of position, time, camera orientation, mobile device velocity, shake/rattle/roll (SRR) data, or audio data.

17. The method of claim 15, further comprising capturing, by the computing device, the image using a camera in communication with the computing device.

18. The method of claim 15, wherein the identifier comprises one or more of the symmetric key or a concatenation of the symmetric key and at least a portion of the metadata.

19. The method of claim 15, further comprising:
sending, to the verification subsystem, an identifier associated with the computing device.

20. The method of claim 15, further comprising:
receiving one or more clues related to a consumer good, wherein the watermarked image is associated with the one or more clues;
receiving an indication that the watermarked image is a solution to the one or more clues, wherein the indication is received in response to the verification subsystem determining, based on an object present in the watermarked image, that the watermarked image is the solution to the one or more clues; and
receiving another clue related to the consumer good.
